(19) United States
(12) Patent Application Publication
(10) Pub. No.: US 2024/0384879 A1
(43) Pub. Date: Nov. 21, 2024

(54) DRAW-THROUGH FAN ASSEMBLY AND HEAT EXCHANGER SYSTEM

(71) Applicant: Carrier Corporation, Palm Beach Gardens, FL (US)

(72) Inventors: Danny Nguyen, Syracuse, NY (US); Peter Bushnell, Cazenovia, NY (US); Ryan Dygert, Cicero, NY (US); Charbel Rahhal, Lyon (FR); Michael Stark, Mooresville, NC (US)

(21) Appl. No.: 18/659,892

(22) Filed: May 9, 2024

Related U.S. Application Data
(60) Provisional application No. 63/503,371, filed on May 19, 2023.

(51) Int. Cl. F24F 1/0029

(52) U.S. Cl. CPC F24F 1/0029

(57) ABSTRACT

A draw-through fan assembly and heat exchanger system configuration is disclosed, comprising a fan deck adapted to mount the fan assembly, an axial fan with a rotating shroud, a heat exchanger section located upstream of the fan and the fan assembly, and a J-shaped inlet bell mouth configured upstream of the fan deck that is located within a space between heat exchangers. Further, a motor associated with the fan assembly and one or more motor struts are positioned upstream of the fan. The fan is mounted on the bottom of the struts, such that once the fan-mounted assembly is configured at the outlet of the heat exchangers, the bell mouth and fan remain below the fan deck and are disposed in a space between the heat exchangers.

### CROSS-REFERENCE TO RELATED APPLICATION

This patent application claims the benefit of U.S. Provisional Patent Application No. 63/503,371, filed on May 19, 2023, which is incorporated by reference herein in its entirety.

### BACKGROUND

This invention relates to the field of cooling and air conditioning systems, and more particularly, a draw-through fan assembly and heat exchanger system configuration.

### SUMMARY

A draw-through fan assembly and heat exchanger system comprises a fan deck adapted to mount a fan assembly. The fan assembly comprises an axial fan with a rotating shroud. A heat exchanger section located is located upstream of the fan and the fan assembly. A J-shaped inlet bell mouth configured upstream of the fan deck is located within a space between heat exchangers. A motor associated with the fan assembly and one or more motor struts are positioned upstream of the fan.

In one or more embodiments, the bell mouth comprises one or more holes at the bottom to drain water collected in the bell mouth.

In one or more embodiments, the one or more holes of the bell mouth are louvered to facilitate leakage air flow turning.

In one or more embodiments, the bell mouth comprises turbulence control fences.

In one or more embodiments, the bell mouth is made of polymeric material.

In one or more embodiments, a discharge grille is positioned downstream of the fan.

In one or more embodiments, the discharge grille comprises a step diffuser having a diameter greater than the diameter of the fan.

In one or more embodiments, the discharge grille comprises air guide vanes.

In one or more embodiments, the fan is configured to discharge air vertically upward.

In one or more embodiments, the heat exchanger section comprises one or more heat exchangers configured in a V or W coil arrangement.

In one or more embodiments, a bottom curved periphery of the J-shaped bell-mouth comprises depressions complimentary to the profile of the heat exchangers.

In one or more embodiments, the one or more motor struts are U-shaped, wherein a bottom of the U-shaped strut is adapted to mount the motor, a top of the U-shaped strut attaches to the fan deck, and sides of the U-shaped strut remain in frictional contact with the bell mouth.

In one or more embodiments, the outer surface of the bell mouth comprises one or more grooves that are adapted to engage with and remain in frictional contact with the motor struts.

In one or more embodiments, each of the motor struts comprises an engaging portion on the inner side of the struts, which is adapted to engage with and remain in frictional contact with the corresponding grooves of the bell mouth.

In one or more embodiments, the motor struts are made of steel.

The foregoing summary is illustrative only and is not intended to be in any way limiting. In addition to the illustrative aspects, embodiments, and features described above, further aspects, embodiments, features, and techniques of the invention will become more apparent from the following description taken in conjunction with the drawings.

### BRIEF DESCRIPTION OF THE DRAWINGS

The accompanying drawings are included to provide a further understanding of the subject disclosure of this invention and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a schematic diagram illustrating an axial shrouded fan of a fan assembly configured upstream of a fan deck, where a motor and motor struts are positioned upstream of an axial fan.

FIG. 2 is a cross-section view of the fan assembly depicting the stepped diffuser employed in the fan assembly.

FIG. 3 is a schematic diagram depicting the fan assembly of FIG. 1 being configured with two flat coils heat exchangers in a V-shape arrangement.

FIGS. 4A and 4B are exemplary views of the bell mouth depicting louvered water drain holes.

FIG. 5 is a schematic diagram illustrating an exemplary embodiment of the outlet grille used in the fan assembly.

FIG. 6 is a schematic diagram illustrating another exemplary embodiment of the inlet of the fan assembly being fitted with turbulence control fences.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the disclosure, the components described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, as the fan assembly, fan deck, shrouded fan, bell mouth, struts, heat exchangers, and corresponding components, described herein may be oriented in any desired direction.

Described herein is a draw-through fan assembly and heat exchanger system configuration that enables the use of large face area heat exchangers without increasing the overall height of the cooling system. The invention achieves this by adjusting the vertical position of the fan assembly and discharge stack, dropping them down into the space between the heat exchangers. The invention includes an inlet that will be shaped to optimize airflow and noise while being coordinated with the fan motor struts to attenuate vibrations.

Accordingly, upon integrating the fan assembly with the heat exchanger system, the bell mouth and the fan remain below the fan deck and are disposed of within a space between the heat exchangers. The cooling system may also be a part of a chiller. As a result, the overall height of the cooling system or the chiller is reduced. Alternatively, this enables the use of larger heat exchangers while maintaining the same height as existing cooling systems. This provides potential to make the cooling system or chiller more compact and/or improve its efficiency.

In addition, as the inner side of the motor struts remains in frictional contact with the outer surface of the bell mouth, this invention is capable of absorbing vibration and of the fan and motor subsystem.

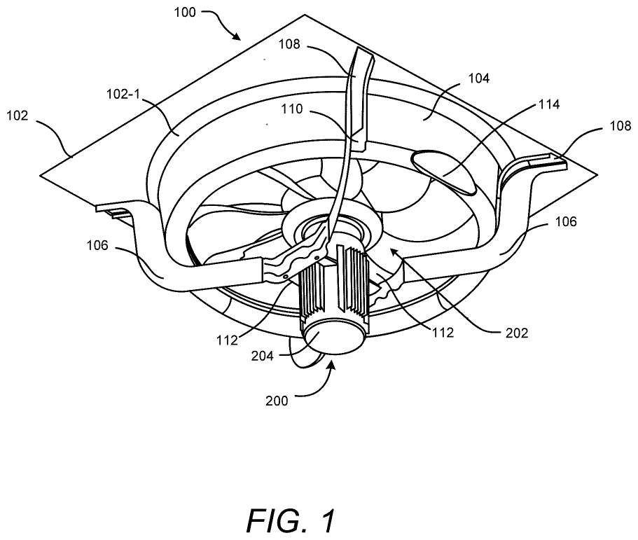

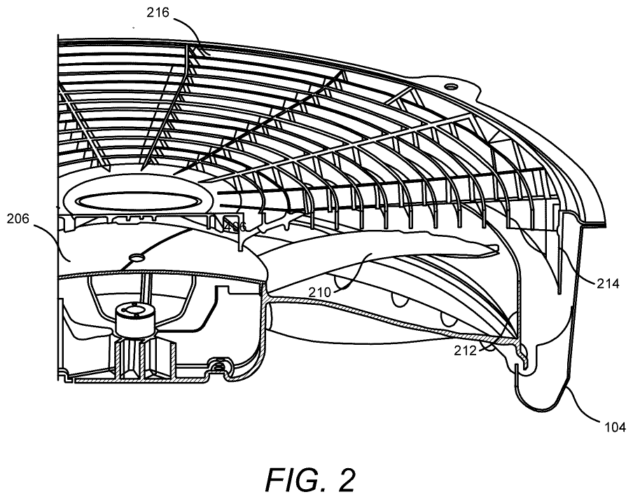

Referring to FIGS. 1 and 2, an exemplary embodiment of the draw-through fan assembly 200 (also referred to as fan assembly, herein) fitted in a configuration 100 comprising a fan deck 102, a bell mouth 104, and motor struts 106 is disclosed. The fan assembly 200 includes an axial shrouded fan 202 that is positioned upstream of the fan deck 102 forming a draw-through fan configuration that discharges air vertically upward. The fan assembly 200 includes the shrouded fan 202 concentrically mounted within the configuration 100 (fan deck 102, bell mouth 104, and motor struts 106).

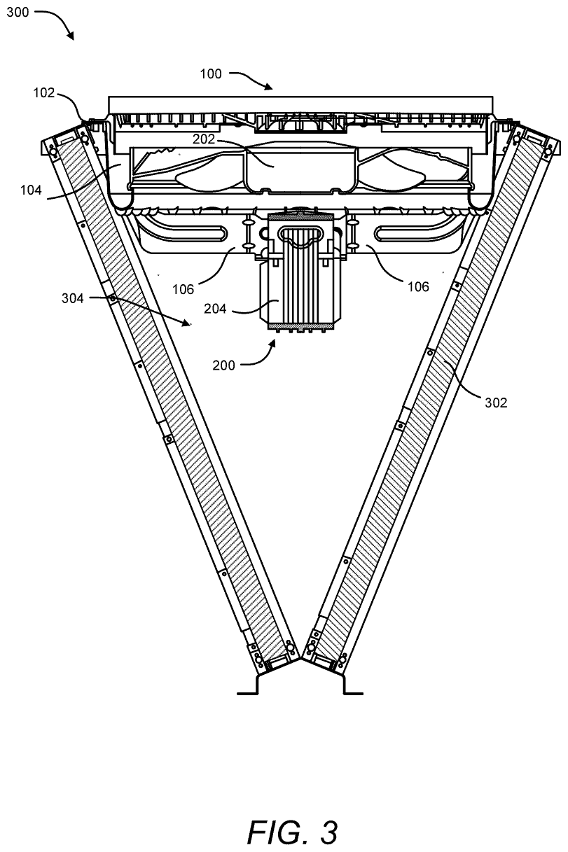

The fan deck 102 has a flat profile with an opening, which is adapted to be fitted at the outlet of the heat exchanger section. The heat exchanger section may include one or more heat exchangers 302 that may be a flat, curved, Y-shaped, Z-shaped or of any other shape, which may be arranged vertically or obliquely or in any other orientation to form arrangements including but not limited to V or W coil arrangements. The fan deck 102 has a dimension based on the outlet of the heat exchanger section 302. An upstream of the fan deck 102 corresponds to the bottom side of the fan deck 102 that is facing the heat exchanger 302 and downstream (opposite to the upstream) of the fan deck 102 corresponds to the top side that is above the fan deck 102. The bell mouth 104 has a J-shape contour inserted or fitted upstream of the fan deck 102. The bell mouth 104 can have a profile and dimension based on a space 304 between the heat exchangers 302, such that once the fan assembly 200 is fitted at the outlet of the heat exchangers 302, the bell mouth 104 and shrouded fan 202 remains below the fan deck 102 and in the space 304 between the heat exchangers 302 as shown in FIG. 3.

The motor struts 106 have a substantially U-shaped profile configured upstream of the bell mouth 104 and the fan deck 102 such that the struts 106 extend along an outer surface of the bell mouth 104, from the bottom end to the top end of the bell mouth 104 and further extending substantially parallel to the bottom surface of the fan deck 102, wherein the top end of the struts 106 are attached to the bottom surface of the fan deck 102, and at least a portion of the inner side of the struts 106 remain in frictional contact with an outer surface of the bell mouth 104. The configuration 100 of FIG. 1 mounts and supports a motor 204 associated with the fan 202 on the bottom of the struts 106, such that the motor 204 and the motor struts 106 remains upstream of the fan 202 and the fan 202 remains concentrically disposed within the bell mouth 104. Accordingly, upon integrating the fan assembly 200 at the outlet of the heat exchanger 302, the bell mouth 104 and the mounted shrouded fan 202 remain below the fan deck 102 and are disposed within the space 304 between the heat exchangers 302 in the cooling system 300 as shown in FIG. 3

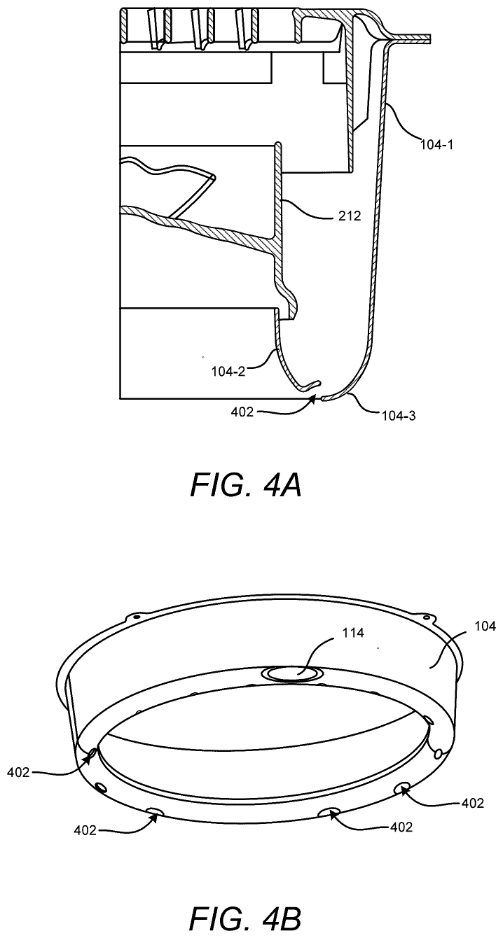

The fan assembly 200 is adapted to be configured with various types of heat exchangers having different coil arrangements such as but not limited to “U’, ‘V’, or “W” shapes. The profile and dimension of the bell mouth 104 can be chosen based on the coil arrangement of the heat exchanger. For instance, in the case of a V-shaped coil arrangement (as shown in FIG. 3), the bell mouth is J-shaped where the diameter of the bell mouth 104 decreases from the top end (i.e, at the rim of the fan deck 102) toward the bottom end, which allows the bell mouth 104 to be positioned in the space 304 between the heat exchangers 302. Referring to FIGS. 2 and 4A, the bell mouth 104 includes an outer section 104-1 having its diameter decreasing from the top end to the bottom end and having a first predefined height based on the height of the fan 202 to be mounted such that the fan 202 remains within the bell mouth 104. The bell mouth 104 further includes a vertical inner section 104-2 having a diameter less than the diameter of the bottom end of the outer section 104-1. The inner section 104-2 has a second predefined height much shorter than the first predefined height of the outer section 104-1 of the bell mouth 104, The inner section 104-2 remains connected to the bottom end of the outer section 104-1 by a curved section 104-3 at the bottom of the bell mouth 104, thereby forming the bell mouth having the J-shaped contour or profile.

Similarly, the dimension and shape of the fan deck 102 can be chosen to fit at the outlet of the heat exchanger 302. In one or more embodiments, the fan deck 102 is square or rectangular-shaped.

The rim of the opening of the fan deck 102 can have shortened inclined or curved extension 102-1 protruding on the inlet side (bottom) of the fan deck 102 for stiffness. The bell mouth 104 can be removably inserted within the opening of the fan deck 102 such that the rim of the fan deck 102 engages and locks with the top end of the bell mouth 104 and the bottom of the bell mouth 104 remains below the fan deck 102. In another instance, the bell mouth 104 can be an integral part of the fan deck 102 to form the casing, wherein the bell mouth 104 protrudes in a downward direction from the rim of the opening of the fan deck 102.

Referring back to FIG. 1, the strut 106 can have a predefined profile based on a profile of the outer surface of the bell mouth 104 such that the struts 106 extend axially along the outer surface of the bell mouth 104, and further extending substantially parallel to the bottom surface of the fan deck 102. The struts 106 can have a substantially U-shaped profile, extending on opposite sides along the outer surface of the bell mouth 104 up to the bottom surface of the fan deck 102. The top end of the U-shaped strut 106 can be substantially parallel to the bottom surface of the fan deck 102. The inner side of each U-shaped strut 106 includes an engaging portion 108 that extends perpendicular to the flat surface of the struts 106. Further, the outer surface of the bell mouth 104 includes grooves 110 at predefined positions. The engaging portion 108 can have a profile concurrent to a profile of the grooves 110 on the bell mouth 104. The engaging portion 108 of the struts 106 are adapted to remain engaged and in frictional contact with one of the grooves 110 of the bell mouth 104. Furthermore, the bottom of the U-shaped struts 106 have mounting elements 112 at the bottom to mount the motor 204.

The outer surface of the bell mouth 104 includes depressions 114 concurrent to a profile of the heat exchangers 302 to provide clearance and facilitate the integration of the bell mouth 104 and the fan 202 below the fan deck 102, within the space 304 between the heat exchangers 302. The depressions 114 allow clearance between the fan assembly 100 and the heat exchanger 302. The depressions 114 can be provided at the bottom curved periphery (curved section 104-3) of the bell mouth 104 and/or at other areas of the outer surface of the bell mouth 104 as required.

Those skilled in the art will appreciate that upon integrating the fan assembly 200 at the outlet of the heat exchanger 302, the bell mouth 104 and shrouded fan 202 remain below the fan deck 102 and are disposed of within the space 304 between the heat exchangers 302. As a result, the overall height of the cooling system 300 in this invention remains less than that of the existing cooling systems, which enables the use of larger heat exchangers 302 while maintaining the same height of the overall cooling system 300. This provides significant potential to keep the cooling system 300 compact and/or improve its efficiency

The bell mouth 104 is made of a polymeric material such as propylene and the struts 106 are made of a metal or metal alloy such as steel. In addition, as the inner side of the struts 106 remain in frictional contact with the outer surface of the bell mouth 104, the system is capable of absorbing vibration and attenuating noise generated by the shrouded fan 202 and motor.

Referring to FIG. 2, the shrouded fan 202 includes a plurality of fan blades 210 extending from the rotor hub 206 about a central axis of the fan 202 and terminating at a fan shroud 212. The fan shroud 212 extends circumferentially around a central axis of the fan 202 and is secured to the plurality of fan blades 210 and also rotates about the fan axis therewith. In some embodiments, the fan shroud 212 comprises an S-shaped curve located on the upstream end of the shroud, in which the outer diameter of the S-shaped curve has a diameter larger than the inner diameter of bell mouth 104. In some embodiments, the fan 202 further includes a stator assembly including a plurality of stator vanes, located downstream of the fan rotor. The hub 206 of the fan 202 is mounted on the motor 204 located at the bottom of the U-shaped struts 106. Blades 210, stator vanes, and rotor hub remain within the bell mouth 104.

Referring to FIGS. 4A, 4B and 6, the bell mouth 104 includes one or more louvered water drain holes 402, at the bottom of the bell mouth 104. The louvered profile of the drain holes 402 facilitates leakage airflow turning and interaction towards an inlet of the bell mouth 104. In some embodiments, as shown in FIG. 6, the bell mouth 104 includes turbulence control fences 602 to reduce air turbulence at the inlet of the fan 202 and further reduce fan noise.

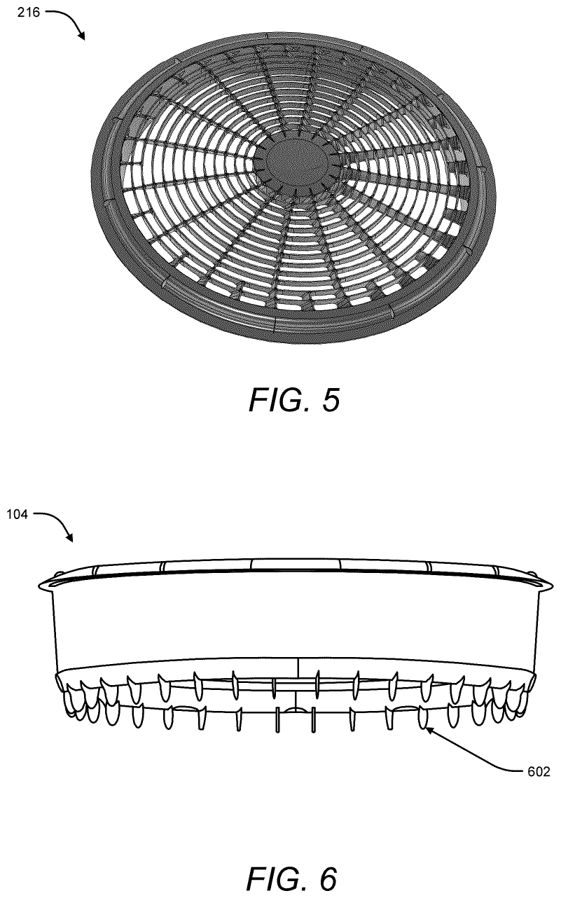

The fan assembly further includes discharge grille 216 as shown in FIG. 5, which has a circular profile configured downstream of the opening of the fan deck 102. The discharge grille 216 can be specially designed to shorten its height, such that a minimal part or no part of the discharge grille 216 remains above the fan deck 102. The discharge grille 216 allows air to flow out of the fan assembly or heat exchanger and restricts outside objects from falling into the fan assembly or heat exchanger.

Referring back to FIG. 2, the discharge grille includes a stepped diffuser 214 having a diameter greater than the diameter of the rotating fan shroud 212 but less than the diameter of the bell mouth 104 such that the diffuser wall 214 extends from the bottom of the fan deck 102 up to a predefined depth in a downward direction within the bell mouth 104, thereby forming a step diffuser configuration.

Thus, the invention enables the use of larger heat exchangers without increasing the overall height of the cooling system, by adjusting the vertical position of the fan assembly and discharge stack, dropping them down into the empty space between the heat exchangers and allowing the addition of coil length while maintaining an equivalent box size and restricting vibration forces and attenuate noise generated by the fan and motor.

While the invention has been described with reference to exemplary embodiments, it will be understood by those skilled in the art that various changes may be made and equivalents may be substituted for elements thereof without departing from the scope of the invention as defined by the appended claims. Modifications may be made to adopt a particular situation or material to the teachings of the invention without departing from the scope thereof. Therefore, it is intended that the invention not be limited to the particular embodiment disclosed, but that the invention includes all embodiments falling within the scope of the invention as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A draw-through fan assembly and heat exchanger system comprising:
a fan deck adapted to mount a fan assembly;
the fan assembly comprising an axial fan with a rotating shroud;
a heat exchanger section located upstream of the fan and the fan assembly; and
a J-shaped inlet bell mouth configured upstream of the fan deck that is located within a space between heat exchangers;
wherein a motor associated with the fan assembly and one or more motor struts are positioned upstream of the fan.

2. The fan assembly and heat exchanger system of claim 1, wherein the bell mouth comprises one or more holes at a bottom of the bell mouth to drain water collected in the bell mouth.

3. The fan assembly and heat exchanger system of claim 2, wherein the one or more holes of the bell mouth are louvered to facilitate leakage air flow turning.

4. The fan assembly and heat exchanger system of claim 1, wherein the bell mouth comprises turbulence control fences.

5. The fan assembly and heat exchanger system of claim 1, wherein the bell mouth is made of polymeric material.

6. The fan assembly and heat exchanger system of claim 1, wherein a discharge grille is positioned downstream of the fan.

7. The fan assembly and heat exchanger system of claim 6, wherein the discharge grille comprises a step diffuser having a diameter greater than diameter of the rotating shroud.

8. The fan assembly and heat exchanger system of claim 6, wherein the discharge grille comprises air guide vanes.

9. The fan assembly and heat exchanger system of claim 1, wherein the fan is configured to discharge air vertically upward.

10. The fan assembly and heat exchanger system of claim 1, wherein the heat exchanger section comprises one or more heat exchangers configured in a V or W coil arrangement.

11. The fan assembly and heat exchanger system of claim 1, a bottom curved periphery of the J-shaped bell-mouth comprises depressions complimentary to the profile of the heat exchangers.

12. The fan assembly and heat exchanger system of claim 1, wherein the one or more motor struts are U-shaped,
wherein,
a bottom of the U-shaped strut is adapted to mount the motor;
a top of the U-shaped strut attaches to the fan deck; and
sides of the U-shaped strut remain in frictional contact with the bell mouth.

13. The fan assembly and heat exchanger system of claim 1, wherein the outer surface of the bell mouth comprises one or more grooves that are adapted to engage with and remain in frictional contact with the motor struts.

14. The fan assembly and heat exchanger system of claim 1, wherein each of the motor struts comprises an engaging portion on the inner side of the struts, which is adapted to engage with and remain in frictional contact with the corresponding grooves of the bell mouth.

15. The fan assembly and heat exchanger system of claim 12, wherein the motor struts are made of steel.
